(19) United States
(12) Patent Application Publication
(10) Pub. No.: US 2003/0091874 A1
(43) Pub. Date: May 15, 2003

(54) Method and apparatus to control water balance in a fuel cell system

(75) Inventor: Uwe Griesmeier, Markdorf (DE)

Correspondence Address: SEED INTELLECTUAL PROPERTY LAW GROUP PLLC, 701 FIFTH AVE, SUITE 6300, SEATTLE, WA, 98104-7092, US

(73) Assignee: Ballard Power Systems AG, Kirchheim-Nabern (DE)

(21) Appl. No.: 10/274,516

(22) Filed: Oct. 18, 2002

(30) Foreign Application Priority Data
Oct. 18, 2001 (DE) 10151520.0

(51) Int. Cl. H01M 8/04

(52) U.S. Cl. 429/13; 429/24; 429/25; 429/34

(57) ABSTRACT

A fuel cell system and method for operating a fuel cell system have a water separator for extracting water contained in a fuel cell exhaust stream. The method comprises varying the pressure of the fuel cell exhaust stream in response to a change in ambient temperature in the vicinity of the fuel cell system. The pressure can be varied by the use of a flow control device positioned downstream of the fuel cell and operationally linked to an ambient temperature sensor.

### CROSS-REFERENCE TO RELATED APPLICATION

This application claims the benefit of German Patent Application No. 10151520.0 filed Oct. 18, 2001, which application is incorporated herein by reference in its entirety.

### BACKGROUND OF THE INVENTION

1. Field of Invention

This invention generally relates to a method and apparatus for operating a fuel cell system and, more specifically, to water management within a fuel cell system.

2. Description of the Related Art

It is well known that water is required for the operation of fuel cell systems. This water is used, for example, to humidify the membranes of PEM fuel cells. Larger quantities of water are typically required by fuel cell systems that contain a fuel processing system, in which a hydrogen-rich gas is produced from hydrocarbons. In order to avoid having to constantly replenish the fuel cell system with water, water contained in fuel cell exhaust streams is used. Because the water in fuel cell exhaust streams is typically in the form of steam, it has to be condensed if it is to be provided to a storage tank in liquid form.

International PCT Application Publication No. WO 00/39874 discloses a device, which condenses water contained in a fuel cell exhaust stream, whereby under certain operating conditions the pressure of the fuel cell exhaust stream is increased by means of a compressor. This changes what would otherwise be the dew point of the water in the fuel cell exhaust stream (according to the prevailing ambient conditions), such that it becomes possible to condense a higher quantity of water than would normally be possible. In the device disclosed in published PCT WO 00/39874, the condensed water is then fed to a coolant reservoir. Subsequently, the condensed water flows into a water circuit that is used to cool and supply water to the fuel cell system. However, because of the presence of an additional compressor, such a system has the disadvantage of increasing the complexity of the fuel cell system design, of increasing the fuel cell system space requirements and of increasing the weight of the fuel cell system. These are significant disadvantages in mobile applications such as fuel cell powered motor vehicles.

Accordingly, there remains a need for a method and apparatus for operating a fuel cell system, in relation to water management. The present invention fulfills this need and provides other related advantages.

### BRIEF SUMMARY OF THE INVENTION

A method is provided for operating a fuel cell system having a water separator for extracting water contained in a fuel cell exhaust stream. The method comprises varying the pressure of the fuel cell exhaust stream in response to a change in ambient temperature in the vicinity of the fuel cell system. This pressure change may be brought about by varying the flow of the fuel cell exhaust stream. This flow variation may occur at a position downstream of the water separator.

A fuel cell system is also provided, the system comprising a fuel cell, a water separator for extracting water contained in an exhaust stream of the fuel cell, and a device for varying the pressure of the exhaust stream in response to a change in ambient temperature in the vicinity of the fuel cell system.

The device may comprise a temperature sensor for monitoring ambient temperature in the vicinity of the fuel cell system, and a flow control device for varying the flow rate of the exhaust stream, the flow control device being operationally linked to the temperature sensor. The flow control device may be positioned downstream of the water separator.

These and other aspects of the invention will be evident upon reference to the attached figures and following detailed description.

### BRIEF DESCRIPTION OF THE DRAWINGS

FIG. 1 shows a schematic representation of an embodiment of a fuel cell system comprising a water separator, and in which the pressure of an exhaust stream can be varied in response to a change in ambient temperature.

FIG. 2 shows a schematic representation of an alternative embodiment of a fuel cell system comprising a water separator, and in which the pressure of an exhaust stream can be varied in response to a change in ambient temperature.

### DETAILED DESCRIPTION OF THE INVENTION

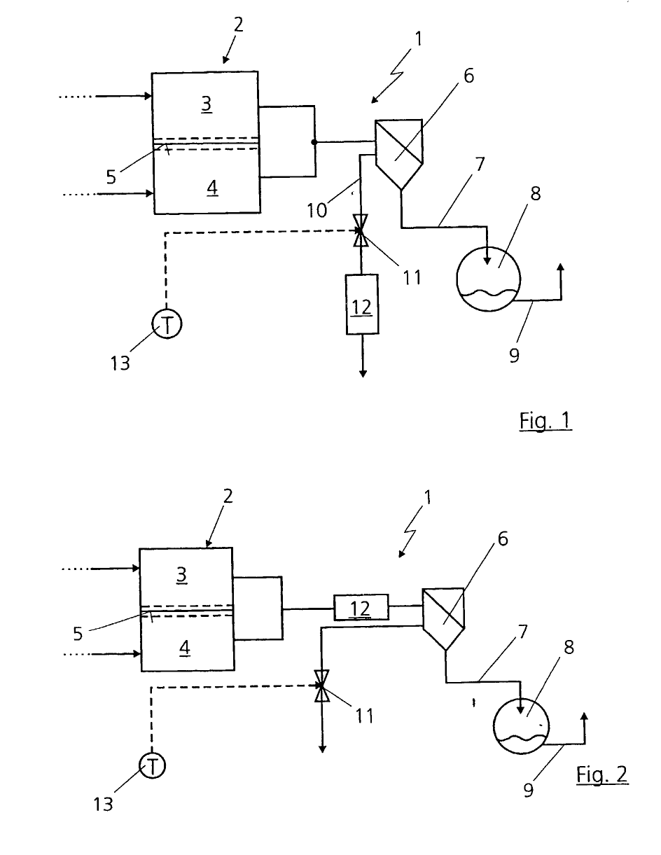

FIG. 1 shows schematically a fuel cell system 1, illustrating in particular a fuel cell 2. Other peripheral devices, such as fuel processing systems or reactant storage and supply systems, which are well known, are not shown for reasons of clarity. However, these peripheral devices, when they are present, do form part of fuel cell system 1. In one embodiment, fuel cell 2 is a PEM fuel cell, with an anode chamber 3 and a cathode chamber 4 separated by a membrane 5.

The fuel and oxidant exhaust streams from anode chamber 3 and cathode chamber 4, respectively, are combined and are directed to a condenser 6, which serves as a water separator in which water vapor is condensed and separated from such exhaust streams. Subsequently, the separated water is directed via a first water conduit 7 into a water tank 8. The separated water in tank 8 is made available to fuel cell system 1 for various purposes, such as humidification and/or fuel processing, via a second water conduit 9, which comprises appropriate conveying means.

The water having been separated from it, the combined exhaust stream is then directed, via a gas conduit 10 and a flow-control device 11, to a catalytic burner 12. Catalytic burner 12 converts the residual fuel and oxidant, contained in the combined exhaust stream, into useable heat for fuel cell system 1, for example for use in a fuel processing system.

Fuel cell system 1 comprises a temperature sensor 13, which monitors the ambient temperature T surrounding fuel cell system 1. In the illustrated embodiment, flow control device 11 is controlled in dependence on ambient temperature T.

Using flow control device 11 as a pressure regulator results in a simple and effective design of fuel cell system 1. However, there are other ways to regulate pressure in fuel cell system 1 within the desired range, which is set in relation to ambient temperature T; for example, an expander with variable turbine geometry can be used.

As mentioned previously, temperature sensor 13 monitors ambient temperature T in the vicinity of fuel cell system 1. The temperatures that exhaust gases can be brought to within condenser 6 (obtainable condenser temperatures) depend on ambient temperature T, which, for example, in the case of a fuel cell system used in a motor vehicle application, would be close to the temperature outside of the motor vehicle. The dew point of the fuel cell exhaust gases depends on the pressure that prevails in fuel cell system 1, and, more specifically the pressure that prevails within condenser 6. In an embodiment of the present method, the dew point of the fuel cell exhaust gases is continuously adapted to these obtainable condenser temperatures by varying the pressure. This results in a very efficient condensation of the water present in the fuel cell exhaust stream, thereby making it possible to maintain water balance in fuel cell system 1 without further water refill requirements.

By regulating pressure in dependence on ambient temperature T, it becomes possible to create a system with reduced complexity, space requirement, and weight. A control device can then continuously adapt saturation temperature to the obtainable condenser temperatures.

In a representative method, an increase in ambient temperature T will typically result in the pressure in condenser 6 being increased, by adjusting flow control valve 12. This will ensure that sufficient quantities of water are condensed from the exhaust streams of fuel cell 2 by condenser 6, even in cases where ambient temperature T is high.

However, pressure typically only has to be increased if there is a risk of fuel cell system 1 no longer achieving water balance. Water balance is to be understood as an operational state in which no water from external sources needs to be added to fuel cell system 1.

Due to the direct relationship between ambient temperature T of fuel cell system 1 and the obtainable condensation temperatures, it becomes possible at an early stage to detect if insufficient water is being condensed. This gives fuel cell system 1 a faster response time regarding water balance issues when compared with systems which use a fill level sensor in the water tank as the triggering mechanism for addressing such issues.

The advantage of this faster response time is that a smaller water tank can be used in fuel cell system 1. The smaller water tank frees more space and reduces weight. This is especially advantageous if fuel cell system 1 is used in a motor vehicle application.

FIG. 1 shows an embodiment of the invention that is representative for motor vehicle applications. Fuel cell system 1 may have a fuel processing system for converting hydrocarbons into a hydrogen-rich gas. This embodiment is simple and compact and the cooling required within condenser 6 is not too high, because catalytic burner 12, which produces additional heat, is positioned downstream of condenser 6 and flow control device 1.

FIG. 2 shows an alternative embodiment of the invention where catalytic burner 12 is located upstream of condenser 6 and flow control device 11 (i.e., between condenser 6 and fuel cell 2). This design, which requires more cooling within condenser 6, can, for example, be used in stationary applications such as cogeneration power systems. The required cooling rate within condenser 6 can be attained by means of fan systems, because space and weight issues are of lesser importance in stationary applications (when compared to motor vehicle applications).

While particular elements, embodiments and applications of the present method and apparatus have been shown and described herein, it will be understood, of course, that the invention is not limited thereto since modifications may be made by those skilled in the art, particularly in light of the foregoing teachings. For example, it is possible pursuant to this invention not to merge the cathode exhaust stream and the anode exhaust stream. In such an embodiment, one or both exhaust stream conduits could have its own condenser and its own flow control device.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

What is claimed is:

1. A method for operating a fuel cell system having a water separator for extracting water contained in a fuel cell exhaust stream, the method comprising varying the pressure of the fuel cell exhaust stream in response to a change in ambient temperature in the vicinity of the fuel cell system.

2. The method of claim 1 wherein the pressure of the fuel cell exhaust stream is varied by varying the flow rate of the fuel cell exhaust stream in dependence on the ambient temperature.

3. The method of claim 2 wherein the flow rate of the fuel cell exhaust stream is varied at a position downstream of the water separator.

4. The method of claim 1 wherein the fuel cell exhaust stream comprises a fuel exhaust stream and an oxidant exhaust stream, and wherein both the fuel exhaust stream and the oxidant exhaust stream are combined downstream of the fuel cell and upstream of the water separator.

5. The method of claim 4 wherein the pressure of the fuel cell exhaust stream is varied by varying the flow rate of the fuel cell exhaust stream in dependence on the ambient temperature at a position downstream of the water separator, the method further comprising directing the fuel cell exhaust stream from the water separator to a catalytic burner.

6. A fuel cell system comprising:
a fuel cell;
a water separator for extracting water contained in an exhaust stream of the fuel cell; and
a device for varying the pressure of the exhaust stream in response to a change in ambient temperature in the vicinity of the fuel cell system.

7. The fuel cell system of claim 6 wherein the device comprises:
a temperature sensor for monitoring the ambient temperature; and
a flow control device for varying the flow rate of the exhaust stream,
wherein the flow control device is operationally linked to the temperature sensor.

8. The fuel cell system of claim 7 wherein the flow control device is positioned downstream of the water separator.
